(19) United States
(12) Patent Application Publication
(10) Pub. No.: US 2008/0247759 A1
(43) Pub. Date: Oct. 9, 2008

(54) DEVICES, SYSTEMS AND METHODS FOR AD HOC WIRELESS COMMUNICATION

(76) Inventor: Ajang Bahar, Kitchener (CA)

Correspondence Address: HERMAN & MILLMAN, 141 ADELAIDE ST. WEST, SUITE 1002, TORONTO, ON, M5H 3L5, CA

(21) Appl. No.: 11/697,812

(22) Filed: Apr. 9, 2007

(51) Int. Cl. H04B 10/00

(52) U.S. Cl. 398/118

(57) ABSTRACT

The current options for wireless communication have changed the way people work and the way in which networks can be deployed. However, there remains unresolved problems in the setup and configuration of wireless communication links. Both known cellular and ad hoc wireless networking protocols and systems are deficient in that the ability for users to communicate without a priori knowledge of MAC addresses (represented by phone numbers, IP addresses and the like) is limited or may be compromised in a hostile environment. In contrast, provided by aspects of the present invention are devices, systems and methods for establishing ad hoc wireless communication between users that do not necessarily have MAC addresses and the like for one another. In some embodiments, a first user visually selects a second user and points a coherent light beam at an electronic device employed by the second user. Data specific to the first user is modulated on the coherent light beam, which can then be demodulated when the coherent light beam is received by the electronic device of the second user.

### FIELD OF THE INVENTION

The invention relates to wireless communication, and in particular to devices, systems and methods for ad hoc wireless communication.

### BACKGROUND OF THE INVENTION

The current options for wireless communication have changed the way people work and the way in which networks can be deployed. However, there remains unresolved problems in the setup and configuration of wireless communication links. Amongst such problems is the need to determine the respective Media access Control (MAC) address of a receiver or a group of receivers before communication can actually begin.

In a cellular wireless communication environment the MAC address is typically linked to a phone number that must be known by a transmitter before a wireless communication link can be established between users. This is problematic for at least two reasons. First, two users may be within visual proximity of one another, yet not able to communicate phone numbers to one another. For example, this may occur as a result of environmental factors (e.g. excessive noise) or social factors (e.g. they are in a meeting where speaking out loud would be disruptive) or they are simply not close enough to one another to effectively exchange phone numbers despite being able to see one another. Second, only one of the users may be able to see the other and wishes to make contact but does not have the requisite phone number and is otherwise unable to make contact with the other user who is unaware of the user looking to make contact. In such scenarios, a wireless communication link is likely impossible using a cellular network because there is little chance that the requisite phone number can be determined.

In ad hoc wireless networking, the issue of security arises as a more significant factor. For example, for users employing a Bluetooth™ device, a first individual wishing to initiate a wireless communication link with a second individual is forced to transmit a broadcast message to poll all of the users within the proximity of the first individual in order to establish a link with the specific second individual if the address of the second individual is not known. According to the Bluetooth™ standard, the broadcast message from the first transmitter (master unit) is in the form of an inquiry and multiple page messages to which slave units may respond with respective MAC addresses. The MAC address or other identification of the electronic device belonging to the second individual electronic device may not provide enough information to allow the first individual to distinguish the electronic device belonging to the second individual from all other user devices in the area. As such, the first individual may undesirably establish a link with another user and/or fail to establish the link with the second individual with which communication is truly desired.

It may also be undesirable to send the broadcast message in the first place. The broadcast message provides the MAC address of the device employed by the first individual to all users in the area proximate to the first individual. In a public or hostile environment, the broadcasting of the MAC address may compromise the security of the first individual because the MAC address can be used to electronically compromise the device employed by the first individual or allow others to intercept what might be private communications between the first and second individuals over a Bluetooth™ link.

### SUMMARY OF THE INVENTION

Additionally and/or alternatively, the device includes a view

According to an aspect of an embodiment of the invention, there is provided

a device for transmitting data between two electronic devices, the system including: an optical modem for transmitting data on a coherent light beam; a memory for storing data; a data interface for transmitting and receiving data; and, a controller connectable to the optical modem, the memory and the data interface. The controller having a computer program product including computer usable program code for transmitting data from the device to a second device, the computer usable program code including program instructions for: sensing a user initiated session through the data interface; initially transmitting an unmodulated coherent light beam for a first duration; selecting data specific to the device from the memory; modulating the selected data onto a coherent light beam with the optical modem; and, transmitting the selected data from the optical modem after the first duration.

In some embodiments, the coherent light beam is also visible. Additionally and/or alternatively, in other embodiments, the device also includes a view finder for aiming the coherent light beam. Additionally and/or alternatively, the device includes a LED that is turned on to emit light when coherent light from another similarly configured device is received by the device. In such embodiments, the LED serves the purpose, inter alia, of alerting one of the two users that the coherent light has been received.

In some embodiments, the device also includes an output manipulatable by a user for pointing the coherent light beam at a user selected target. In some more specific embodiments, the device is integrated into a rigid housing. In even more specific embodiments, the rigid housing is approximately 1 to 4 inches in length so as to fit in the hand of an average person.

In some embodiments, the first duration is in the range of 1-3 seconds, so as to allow a user to line up and select the target using the unmodulated coherent light beam.

In some embodiments, the device also includes a user input device connectable to the data interface for operating the device; and, the computer program code having further instructions for: sensing a first input corresponding to a first signal to transmit the unmodulated coherent light beam for the first duration; and, sensing a second input corresponding to a second signal to transmit the modulated coherent light beam after the first duration. In some more specific embodiments, the user input device includes one of a pressure sensor, a push-button, a toggle switch, a touch screen, a key pad and a keyboard. In some even more specific embodiments, the second input is an elongated version of the first input, such that the first signal is converted to the second signal simply by having the user maintain pressure on the user input device.

In some embodiments, the selected data modulated onto the coherent light beam is one of a text message, a phone number, an email address, a Media access Control (MAC) address suitable for a wireless communication link and a wireless session identifier. In some embodiments, the wireless session identifier is a link key suitable for a Bluetooth™ ad hoc wireless session

In some embodiments, the device also includes a coherent light receiver for receiving both modulated and unmodulated light from a second device; and the computer usable program code including further instructions for: determining whether the light is unmodulated or modulated; if the light is modulated, demodulating the modulated light to recover the data modulated thereon; and generating a local signal after demodulating the modulated light.

In some more specific embodiments, the local signal includes at least one of a text message, an email, an audible sound, a vibration and a visual indicator.

In some more specific embodiments, the device also includes a wireless modem suitable for establishing a radio communication link. In some even more specific embodiments, the radio communication link is within at least one of a cellular network and an ad hoc wireless network In some even more specific embodiments, the computer usable program code further comprises program instructions for: initiating a wireless communication session using the data demodulated from a modulated light signal on the wireless modem.

In some more specific embodiments, the data interface is further connectable to at least one of a notebook computer, a cell phone, a personal digital assistant and a personal data communication device, each having an independent wireless modem suitable for establishing a radio communication link. In some even more specific embodiments, the computer usable program code further comprises program instructions for: transmitting a message through the data interface to initiate a wireless communication session using the data demodulated from a modulated light signal on the independent wireless modem.

According to another aspect of an embodiment of the invention, there is provided a system for establishing a wireless radio communication link between two wireless radio communication modems, the system including: a laser modem connectable to a first wireless radio communication modem, the laser modem including: an optical modem for transmitting data on a coherent light beam, a memory for storing data; a data interface for transmitting and receiving data; and a controller connectable to the optical modem, the memory and the data interface. The controller having a computer program product including computer usable program code for transmitting data from the device to a second device, the computer usable program code including program instructions for: sensing a user initiated session through the data interface; initially transmitting an unmodulated coherent beam for a first duration; selecting a Media access Control (MAC) address specific to the first wireless communication modem from the memory; modulating the selected MAC address onto a coherent beam with the optical modem; and transmitting the selected data from the optical modem after the first duration.

In some embodiments, the coherent light beam is also visible. Additionally and/or alternatively, in other embodiments, the device also includes a view finder for aiming the coherent light beam. Additionally and/or alternatively, the device includes a LED that is turned on to emit light when coherent light from another similarly configured device is received by the device. In such embodiments, the LED serves the purpose, inter alia, of alerting one of the two users that the coherent light has been received.

In some embodiments, the laser modem also includes: a coherent light receiver for receiving both modulated and unmodulated light from a second device; and the computer usable program code including further instructions for: determining whether the light is unmodulated or modulated; if the light is modulated, demodulating the modulated light to recover the data modulated thereon; and generating a local signal after demodulating the modulated light.

In some embodiments, the local signal includes at least one of a text message, an email, an audible sound, a vibration and a visual indicator.

In some embodiments, the system also includes a wireless modem suitable for establishing a radio communication link. In some more specific embodiments, the radio communication link is within at least one of a cellular network and an ad hoc wireless network. In some more specific embodiments, the computer usable program code further comprises program instructions for: initiating a wireless communication session using the data demodulated from a modulated light signal on the wireless modem.

In some embodiments, the data interface is further connectable to at least one of a notebook computer, a cell phone, a personal digital assistant and a personal data communication device, each having an independent wireless modem suitable for establishing a radio communication link. In some more specific embodiments; the computer usable program code further comprises program instructions for: transmitting a message through the data interface to initiate a wireless communication session using the data demodulated from a modulated light signal on the independent wireless modem.

According to yet another aspect of an embodiment of the invention, there is provided a method of establishing a wireless communication link between a transmitting device and a receiving device without a priori knowledge of a Media access Control (MAC) address for the receiving device, the method including: initially transmitting an unmodulated coherent light beam for a first duration; directing the unmodulated coherent light towards the receiving device; selecting data specific to the transmitting device from a memory; modulating the selected data onto a coherent light beam with the optical modem; and transmitting the selected data from the transmitting device to the receiving device on the modulated coherent light after the first duration. In some embodiments, the coherent light beam is also visible.

In some embodiments, the method also includes: receiving both modulated and unmodulated light from a second device; determining whether the light is unmodulated or modulated; if the light is modulated, demodulating the modulated light to recover the data modulated thereon; and, generating a local signal after demodulating the modulated light.

In some embodiments, the method also includes initiating a wireless communication session using the data demodulated from a modulated light signal on the wireless modem. In some more specific embodiments, the wireless communication session includes a radio communication link within at least one of a cellular network and an ad hoc wireless network. In some embodiments, the method also includes determining “who” or “what” to engage in communication with through line of sight identification prior to transmitting the selected data from the transmitting device.

Other aspects and features of the present invention will become apparent to those ordinarily skilled in the art, upon review of the following description of the specific embodiments of the invention.

### BRIEF DESCRIPTION OF THE DRAWINGS

For a better understanding of the present invention, and to show more clearly how it may be carried into effect, reference will now be made, by way of example, to the accompanying drawings, which illustrate aspects of embodiments of the present invention and in which:

FIG. 1 is a first system view of a device for transmitting data over a coherent light beam according to aspects of the invention;

FIG. 2 is a second system view of the device shown in FIG. 1 in combination with a user device according to aspects of the invention;

FIG. 3 is a first flow chart illustrating method steps for transmitting data over a coherent light beam according to aspects of the invention; and

FIG. 4 is a second flow chart illustrating method steps for receiving data on a coherent light beam according to aspects of the invention.

### DETAILED DESCRIPTION OF THE INVENTION

The current options for wireless communication have changed the way people work and the way in which networks can be deployed. However, there remains unresolved problems in the setup and configuration of wireless communication links. Amongst such problems is the need to determine the respective Media access Control (MAC) address of a receiver or a group of receivers before communication can actually begin. Both known cellular and ad hoc wireless networking protocols and systems are deficient in that the ability for users to communicate without a priori knowledge of MAC addresses (represented by phone numbers, IP addresses and the like) is limited or may be compromised in a hostile environment.

Provided by aspects of the present invention are devices, systems and methods for establishing ad hoc wireless communication between users that do not necessarily have MAC addresses and the like for one another. In some embodiments, a first user visually selects a second user and points a coherent light beam at an electronic device employed by the second user. Data specific to the first user is modulated on the coherent light beam, which can then be demodulated when the coherent light beam is received by the electronic device of the second user. In some embodiments the coherent light is visible, such as for example, as generated by a laser source.

For wireless communication methods to commence there is required information that determines “who” or “what” to engage communication with before the process of communication could begin. In some embodiments in accordance with aspects of the invention this information is gathered through line of sight and used as identification for purpose of ad hoc wireless communication.

The data specific to the first user can be one of a phone number, an IP address, an email address, a link key for a Bluetooth™ session and a MAC address, or similar information may enable the second user to contact the first user using a wireless communication link. For example, the data received by the second user may be used to establish a radio wireless communication link on a cellular wireless network or an ad hoc Local Area Network (LAN) that, for example, employs the Bluetooth™ standard.

The data modulated onto the coherent light beam is one of a “text message”, a phone number, an email address, a Media access Control (MAC) address suitable for a wireless communication link and a wireless session identifier. For example, according to the Bluetooth™ standard, the wireless session identifier is a link key. Moreover, those skilled in the art will appreciate that a text message may contain a suitable combination of letters, digits, characters and symbols from one or more language alphabets.

Aspects of the invention may be embodied in a number of forms. For example, various aspects of the invention can be embodied in a suitable combination of hardware, software and firmware. In particular, some embodiments include, without limitation, entirely hardware, entirely software, entirely firmware or some suitable combination of hardware, software and firmware. In a particular embodiment, the invention is implemented in a combination of hardware and firmware, which includes, but is not limited to firmware, resident software, microcode and the like.

Additionally and/or alternatively, aspects of the invention can be embodied in the form of a computer program product that is accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by, or in connection with, the instruction execution system, apparatus, or device.

A computer-readable medium can be an electronic, magnetic, optical, electromagnetic, infrared, or semiconductor system (or apparatus or device) or a propagation medium. Examples of a computer-readable medium include a semiconductor and/or solid-state memory, magnetic tape, a removable computer diskette, a random access memory (RAM), a read-only memory (ROM), a rigid magnetic disk and an optical disk. Current examples of optical disks include, without limitation, compact disk-read only memory (CD-ROM), compact disk-read/write (CD-R/W) and DVD.

In accordance with aspects of the invention, a data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Additionally and/or alternatively, in accordance with aspects of the invention, a data processing system suitable for storing and/or executing program code will include at least one processor integrated with memory elements through a system bus.

Input/output (i.e. I/O devices)—including but not limited to keyboards, touch-pads, displays, pointing devices, etc.—can be coupled to the system either directly or through intervening I/O controllers.

Network adapters may also be coupled to the system to enable communication between multiple data processing systems, remote printers, or storage devices through intervening private or public networks. Modems, cable modems and Ethernet cards are just a few of the currently available types of network adapters.

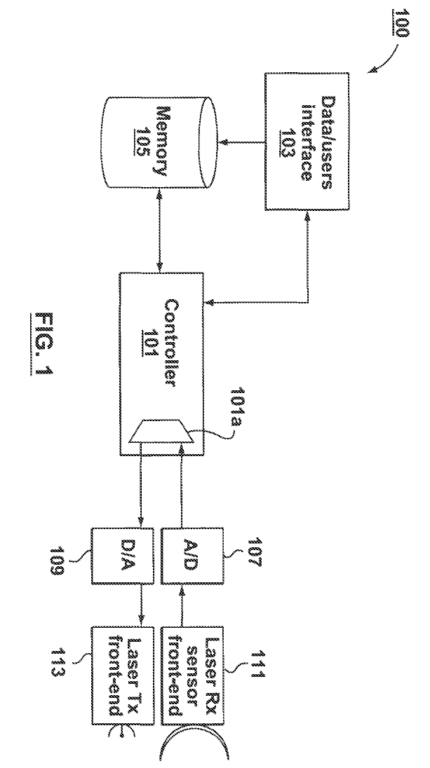

Referring to FIG. 1, shown is a first system view of a device 100 for transmitting data over a coherent light beam according to aspects of the invention. The device 100 includes a controller 101 having a multiplexer (MUX) 110a. The MUX 110a is connected to a transmission branch and a reception branch arranged in parallel to one another. The transmission branch includes digital-to-analog (D/A) converter 109 connected in series between the MUX 101a and a laser signal transmitter (Tx) front end 113. The reception branch includes an analog-to-digital converter 107 connected in series between the MUX 110a and a laser signal receiver (Rx) sensor front end 111. The components of the transmission branch and the reception branch may be considered together as an optical modem suitable for transmitting and receiving optical signals without a fiber optical cable. In some embodiments, the optical modem is an off-the-shelf component that may be integrated with an embodiment of the device 100.

The device 100 also includes a memory module 105 and a data/user interface module 103. The memory module 105 is connected to both the controller 101 and the data/user interface module 103 and serves the purpose of storing local data and computer usable program code. In some embodiments, the computer usable program code includes program instructions for: sensing a user initiated session through the data interface; initially transmitting an unmodulated coherent light beam for a first duration; selecting data specific to the device from the memory; modulating the selected data onto a coherent light beam with the optical modem; and transmitting the selected data from the optical modem after the first duration.

Additionally and/or alternatively, the computer usable program code also includes instructions for determining whether the light is unmodulated or modulated. If the light is modulated, demodulating the modulated light to recover the data modulated thereon; and generating a local signal after demodulating the modulated light. In some very specific embodiments, the local signal includes at least one of a text message, an email, an audible sound, a vibration and a visual indicator.

The data/user interface 105 is also connected to the controller 101 and is provided for transmitting and receiving data either directly from a user or from another electronic device connectable to the device 100. In some embodiments, the device 100 is connectable to electronic devices, such as for example only, and without limitation, cell phones, personal digital assistants (PDAs), personal computers and the like.

In some embodiments the coherent light is visible and in others the coherent light is not visible. As such, when the coherent light is not visible the device 100 is optionally provided with a view finder (not shown) for aiming the coherent light towards a receiving device. In some embodiments, the device 100 also includes an output (not speifically shown) that is manipulatable by a user for pointing the coherent light beam at a user selected target. Moreover, the device may also be integrated into a rigid housing. In order to be considered “hand-size”, in some embodiments, the rigid housing is approximately 1 to 4 inches in length so as to fit in the hand of an average person.

In some embodiments, the first duration is in the range of 1-3 seconds, so as to allow a user to line up and select the target using the unmodulated coherent light beam transmitted from the laser Tx front end 113.

In some more specific embodiments, the data/user interface 103 is connectable to a user input device (not specifically shown). For example, and without limitation, the user input device includes one of a pressure sensor, a push-button, a toggle switch, a touch screen, a key pad or a keyboard. In such embodiments, the computer program code stored in the memory 105 has further instructions for: sensing a first input corresponding to a first signal to transmit the unmodulated coherent light beam for the first duration; and sensing a second input corresponding to a second signal to transmit the modulated coherent light beam after the first duration. In some more specific embodiments, the second input is an elongated version of the first input such that the first signal is converted to the second signal simply by having the user maintain pressure on the user input device.

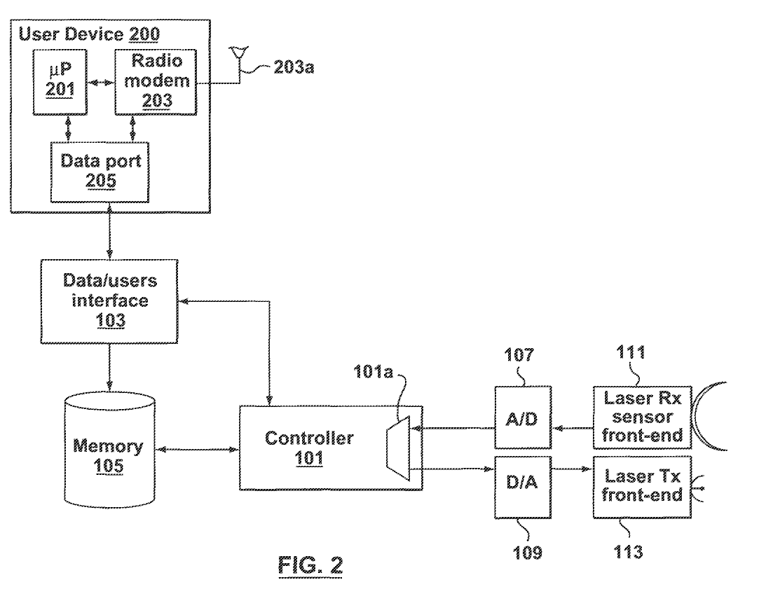

Turning to FIG. 2, shown is a second system view of the device 100 shown in FIG. 1 in combination with a user device 200 according to aspects of the invention. The user device includes a controller (processor) 201, a data port 205 and radio modem 203 that are each connected to one another. The radio modem 203 also includes an antenna 203a. The data port 205 is connectable to the data/user interface 103 of the device 100.

The user device 200 may be one of at least one of a notebook computer, a cell phone, a personal digital assistant and a personal data communication device, each having an independent wireless modem (radio modem 203) suitable for establishing a radio communication link. Accordingly, in such embodiments, the computer usable program code further includes program instructions for: transmitting a message through the data interface to initiate a wireless communication session using the data demodulated from a modulated light signal on the independent wireless modem.

Additionally and/or alternatively, the device 100 and the user device 200 may be integrated with one another so as to provide the device 100 with access to a wireless modem (radio modem 203) suitable for establishing a radio communication link. Accordingly, in such embodiments, the computer usable program code further includes program instructions for initiating a wireless communication session using the data demodulated from a modulated light signal on the wireless modem. Moreover, in such embodiments, the radio communication link is preferably within at least one of a cellular network and an ad hoc wireless network.

In operation, the device 100, controlled by a first user, is used to transmit data wirelessly between first and second user devices without the need for a priori information relating to the MAC address (or the like) of the second user device. The first user directs the coherent and visible light from the device 100 to a second similarly configured device belonging to a second user. Initially, coherent and visible light is unmodulated for a first duration which is regulated internally by the device 100. The first duration provides the first user time to direct or aim the coherent and visible light towards the second similarly configured device. After the first duration, data specific to the device 100 is modulated on the coherent and visible light and transmitted to the second similarly configured device so long as the first user maintains the positioning of the device 100 established during the first duration.

This method of transferring data is effective because the light is both coherent and visible enabling the first user to identify the second user along a line of sight. The fact that the light is coherent ensures that the light and data modulated thereon is transmitted between two points only and is not broadcasted in a spherical wave the way noncoherent light propagates. The fact that it is visible allows users to determine with some degree of accuracy the intended target/recepient of the information. Eavesdroppers or others that may intercept the signal are easily identified as being in the direct path of the coherent and visible light. As such, the first or second user may take precautions to avoid contact with such third parties. In other words, the “who” or “what” to engage in wireless communication with is determined through the line of sight between users in order to establish ad hoc wireless communication.

Additionally and/or alternatively, the first user may direct the coherent and visible light towards a target device used to identify packages, boxes, containers, shelves or the like. Such a device would be similar to a second user device except that it would merely serve as a beacon identifying items in the container or location, and would not be used by a second user. In such embodiments, such the memory of such a device may be updated through control software on the first user device.

Moreover, while the above operation included the use of coherent and visible light, those skilled in the art would appreciate that an embodiment employing coherent and non-visible light is possible and within the scope of the following claims. In such embodiments, a device according to aspects of the invention includes an optional view finder to help a user aim the coherent and nonvisible light towards a receiving device. However, the view finder is not required in all such embodiments. Additionally and/or alternatively, the device includes a LED that is turned on to emit light when coherent light from another similarly configured device is received by the device. In such embodiments, the LED serves the purpose; inter alia, of alerting one of the two users that the coherent light has been received.

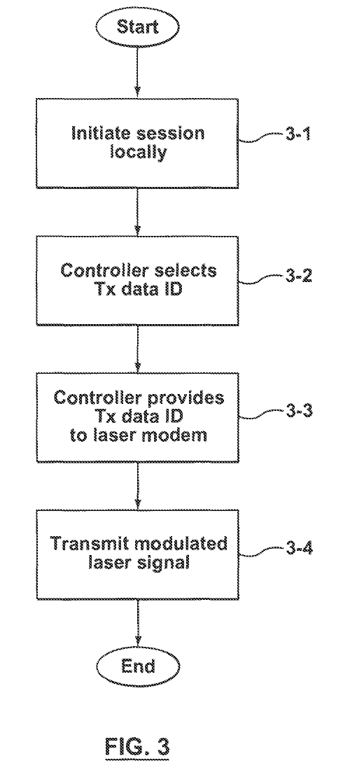

FIG. 3 is a first flow chart illustrating method steps for transmitting data over a coherent light beam according to aspects of the invention. Starting at step 3-1, the method includes initiating a session locally. For example, this may occur with a device provided in accordance with aspects of the invention (e.g., Device 100) coupled with a notebook computer. The user may user a graphical user interface to control the device through the notebook computer or a switch provided on the actual device.

At step 3-2, the method includes selecting transmission data specific to the first user from a memory. For example, the transmission data specific to the first user may be a text message, a phone number, an email address, a Media access Control (MAC) address suitable for a wireless communication link and a wireless session identifier. If Bluetooth™ is the standard employed by a radio modem included with the device, the wireless session identifier is a link key which is used to identify a specific session, without having to negotiate a session between first and second users.

At step 3-3, the method includes providing the transmission data specific to the first user to a laser modem for transmission over the air and not over a fiber optic cable. For example, with reference to FIG. 1, the controller 101 provides the transmission data specific to the first user to the laser Tx front end 113 through the D/A converter 109. At step 3-4, the method includes transmitting the modulated transmission data specific to the first user over a coherent light beam.

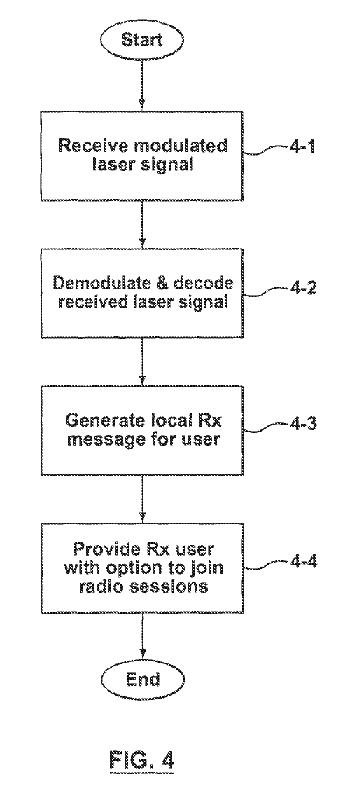

FIG. 4 is a second flow chart illustrating the method steps for receiving data on a coherent light beam according to aspects of the invention. Starting at step 4-1, the method includes receiving a modulated laser signal. Step 4-2 includes demodulating and decoding the received laser signal to determine transmission data specific to the first user sent on the modulated laser signal Step 4-3 includes generating a local message for a receiving user. For example, the local signal includes at least one of a text message, an email, an audible sound, a vibration and a visual indicator. Lastly, at step 44, the method includes providing the receiving user with an option to join a radio communication link session using the transmission data specific to the first user.

While the above description provides example embodiments it will be appreciated that the present invention is susceptible to modification and change without departing from the fair meaning and scope of the accompanying claims. Accordingly, what has been described is merely illustrative of the application of aspects of embodiments of the invention and numerous modifications and variations of the present invention are possible in light of the above disclosure.

1. A device for transmitting data between two electronic devices, the system comprising:
an optical modem for transmitting data on a coherent light beam;
a memory for storing data;
a data interface for transmitting and receiving data, and
a controller connectable to the optical modem the memory and the data interface, the controller having computer program product including computer usable program code for transmitting data from the device to a second device, the computer usable program code including program instructions for:
sensing a user initiated session through the data interface;
initially transmitting an unmodulated coherent light beam for a first duration;
selecting data specific to the device from the memory;
modulating the selected data onto a coherent light beam with the optical modem; and
transmitting the selected data from the optical modem after the first duration.

2. A device according to claim 1, wherein the coherent light beam is visible.

3. A device according to claim 1, further comprising a view finder for aiming the coherent light beam.

4. A device according to claim 1, further comprising an output manipulatable by a user for pointing the coherent light beam at a user selected target.

5. A device according to claim 4, wherein the device is integrated into a rigid housing.

6. A device according to claim 5, wherein the rigid housing is approximately 1 to 4 inches in length so as to fit in the hand of an average person.

7. A device according to claim 1, wherein the first duration is in the range of 1-3 seconds, so as to allow a user to line up and select the target using the unmodulated coherent light beam.

8. A device according to claim 1 further comprising:
a user input device connectable to the data interface for operating the device; and
the computer program code having further instructions for:
sensing a first input corresponding to a first signal to transmit the unmodulated coherent light beam for the first duration; and
sensing a second input corresponding to a second signal to transmit the modulated coherent light beam after the first duration.

9. A device according to claim 8, wherein the user input device includes one of a pressure sensor, a push-button, a toggle switch, a touch screen, a key pad and a keyboard.

10. A device according to claim 8, wherein the second input is an elongated version of the first input, such that the first signal is converted to the second signal simply by having the user maintain pressure on the user input device.

11. A device according to claim 1, wherein the selected data modulated onto the coherent light beam is one of a text message, a phone number, an email address, a Media access Control (MAC) address suitable for a wireless communication link and a wireless session identifier.

12. A device according to claim 11, wherein the wireless session identifier is a link key.

13. A device according claim 1, further comprising:
a coherent light receiver for receiving both modulated and unmodulated light from a second device; and
the computer usable program code including further instructions for:
determining whether the light is unmodulated or modulated;
if the light is modulated, demodulating the modulated light to recover the data modulated thereon; and
generating a local signal after demodulating the modulated light.

14. A device according to claim 13, wherein the local signal includes at least one of a text message, an email, an audible sound, a vibration and a visual indicator.

15. A device according to claim 13, further comprising a wireless modem suitable for establishing a radio communication link.

16. A device according to claim 15, wherein the radio communication link is within at least one of a cellular network and an ad hoc wireless network.

17. A device according to claim 15, wherein the computer usable program code further comprises program instructions for:
initiating a wireless communication session using the data demodulated from a modulated light signal on the wireless modem.

18. A device according to claim 13, wherein the data interface is further connectable to at least one of a notebook computer, a cell phone, a personal digital assistant and a personal data communication device, each having an independent wireless modem suitable for establishing a radio communication link.

19. A device according to claim 18, wherein the computer usable program code further comprises program instructions for:
transmitting a message through the data interface to initiate a wireless communication session using the data demodulated from a modulated light signal on the independent wireless modem.

20. A system for establishing a wireless radio communication link between two wireless radio communication modems, the system comprising:
a laser modem connectable to a first wireless radio communication modem: the laser modem including: an optical modem for transmitting data on a coherent light beam;a memory for storing data; a data interface for transmitting and receiving data; and a controller connectable to the optical modem, the memory and the data interface, the controller having computer program product including computer usable program code for transmitting data from the device to a second device, the computer usable program code including program instructions for:
sensing a user initiated session through the data interface;
initially transmitting an unmodulated coherent light beam for a first duration;
selecting a Media access Control (MAC) address specific to the first wireless communication modem from the memory;
modulating the selected MAC address onto a coherent light beam with the optical modem; and
transmitting the selected data from the optical modem after the first duration.

21. A system according to claim 20, wherein the coherent light beam is visible.

22. A system according to claim 20, wherein the laser modem further comprising:
a coherent light receiver for receiving both modulated and unmodulated light from a second device; and
the computer usable program code including further instructions for:
determining whether the light is unmodulated or modulated;
if the light is modulated, demodulating the modulated light to recover the data modulated thereon; and
generating a local signal after demodulating the modulated light.

23. A system according to claim 22, wherein the local signal includes at least one of a text message, an email, an audible sound, a vibration and a visual indicator.

24. A system according to claim 22, further comprising a wireless modem suitable for establishing a radio communication link.

25. A system according to claim 24, wherein the radio communication link is within at least one of a cellular network and an ad hoc wireless network.

26. A system according to claim 24, wherein the computer usable program code further comprises program instructions for:
initiating a wireless communication session using the data demodulated from a modulated light signal on the wireless modem.

27. A system according to claim 22, wherein the data interface is further connectable to at least one of a notebook computer, a cell phone, a personal digital assistant and a personal data communication device, each having an independent wireless modem suitable for establishing a radio communication link.

28. A system according to claim 27, wherein the computer usable program code further comprises program instructions for:
transmitting a message through the data interface to initiate a wireless communication session using the data demodulated from a modulated light signal on the independent wireless modem.

29. A method of establishing a wireless communication link between a transmitting device and a receiving device without a priori knowledge of a Media access Control (MAC) address for the receiving device, the method comprising:
initially transmitting an unmodulated coherent light beam for a first duration:
directing the unmodulated coherent light towards the receiving device;
selecting data specific to the transmitting device from a memory;
modulating the selected data onto a coherent light beam with an optical modem; and
transmitting the selected data from the transmitting device to the receiving device on the modulated coherent light after the first duration.

30. A method according to claim 29, further comprising:
receiving both modulated and unmodulated light from a second device;
determining whether the light is unmodulated or modulated;
if the light is modulated, demodulating the modulated light to recover the data modulated thereon; and
generating a local signal after demodulating the modulated light.

31. A method according to claim 30, further comprising:
initiating a wireless communication session using the data demodulated from a modulated light signal on the wireless modem.

32. A method according to claim 31, wherein the wireless communication session includes a radio communication link within at least one of a cellular network and an ad hoc wireless network.

33. A method according to claim 32, wherein the coherent light beam is visible.

34. A method according to claim 32, further comprising:
determining “who” or “what” to engage in communication with through line of sight identification prior to transmitting the selected data from the transmitting device.
